(19) United States
(12) Patent Application Publication
(10) Pub. No.: US 2026/0046004 A1
(43) Pub. Date: Feb. 12, 2026

(54) On/off configuration for network-controlled repeater

(71) Applicant: TELEFONAKTIEBOLAGET LM ERICSSON (PUBL), Stockholm (SE)

(72) Inventors: Magnus Åström, Lund (SE); Boris Dortschy, Vendelsö (SE); Behrooz Makki, PIXBO (SE); Lei Bao, Göteborg (SE)

(21) Appl. No.: 19/102,631

(22) PCT Filed: Aug. 9, 2023
(86) PCT No.: PCT/IB2023/058066

§ 371 Date: Feb. 10, 2025

Related U.S. Application Data
(60) Provisional application No. 63/397,746, filed on Aug. 12, 2022.

(51) Int. Cl. H04B 7/06; H04W 76/27

(52) U.S. Cl. CPC H04B 7/06952; H04W 76/27

(57) ABSTRACT

According to certain embodiments, a method is performed by a repeater node having a forwarder (R-Fwd) and a mobile termination (R-MT). The method comprises receiving a beam indication from a network node. The beam indication indicates one or more beams. The method further comprises configuring an ON/OFF status of the R-Fwd based at least in part on the beam indication.

### RELATED APPLICATIONS

This application claims the benefit of provisional patent application Ser. No. 63/397,746, filed Aug. 12, 2022, the disclosure of which is hereby incorporated herein by reference in its entirety.

### TECHNICAL FIELD

Certain embodiments of the present disclosure relate to configuring a repeater in a wireless telecommunications network.

### BACKGROUND

### Network Controlled Repeater

Various options are being considered to increase the data rate and to support an increasing number of user equipment (UEs) in a network. Examples of such options include network densification and millimeter wave (mmW) communications. Network densification refers to the deployment of multiple access points of different types in an area, such as a metropolitan area. It is expected that small nodes will be densely deployed in the future to support existing macro base stations (BS) serving UEs. Examples of such small nodes include relays, Integrated Access and Backhaul (IABs), repeaters, etc. Examples of base stations include gNodeBs (gNBs).

The Third Generation Partnership Project (3GPP) comprises standards organizations that develop technical specifications (TS) for New Radio (NR) and other mobile telecommunications technologies. The 3GPP organizes the technical specifications into releases identified by release number (e.g., Rel-16, Rel-17, Rel-18, etc.). During the development of Rel-16 and Rel-17, the 3GPP studied IAB as the main relaying technique in 5G. In Rel-18, discussions will continue for Mobile IAB. Here, using a decode-and-forward relaying technique, the IAB can well extend the coverage and/or increase the throughput. However, an IAB may be a relatively complex and expensive node. For this reason, certain deployments may require alternative nodes with low complexity/cost, for example, for blind spot removal. Here, a candidate type of network node is a radio frequency (RF) repeater that simply amplifies-and-forwards any signal that it receives. RF repeaters have been considered in 2G, 3G, and 4G to supplement the coverage provided by regular full-stack cells. However, RF repeaters lack certain capabilities, such as accurate beamforming. This may limit the efficiency of the RF repeater in some deployments, for instance, in frequency range 2 (FR2).

With this background, 3GPP Rel-18, started in early 2022, considers a new study-item to evaluate the potential and the challenges of network-controlled repeaters (NCRs). While the scope and the features of NCR are still under discussion, in general, two functions of an NCR include a mobile termination function (NCR-MT) and a forwarding function (NCR-Fwd).

3GPP has introduced a network-controlled repeater study item description (SID), RP-213700. Study item description RP-213700 is titled “New SID on NR Network Controlled Repeaters” and is associated with 3GPP TSG RAN Meeting #94e, Dec. 6-17, 2021. The study item for RP-213700 considers the following focus:
Network-controlled repeaters are inband RF repeaters used for extension of network coverage on frequency range 1 (FR1) and FR2 bands, while during the study FR2 deployments may be prioritized for both outdoor and outdoor-to-indoor (O2I) scenarios;
For only single hop stationary network-controlled repeaters;
Network-controlled repeaters are transparent to UEs;
Network-controlled repeater can maintain the gNB-repeater link and repeater-UE link simultaneously.

Also, the study-item will concentrate on identifying which side control information is required regarding:
Beamforming information;
Timing information to align transmission/reception boundaries of network-controlled repeater;
Information on uplink-downlink time division duplex (UL-DL TDD) configuration;
ON-OFF information for efficient interference management and improved energy efficiency;
Power control information for efficient interference management.

### NR Multi-Beam Operation

### Beam Management Procedure

In high frequency range (e.g., FR2), multiple RF beams may be used to transmit and receive signals at a gNB and a UE. For each downlink (DL) beam from a gNB, there is typically an associated best UE receive (RX) beam for receiving signals from the DL beam. The DL beam and the associated UE RX beam form a beam pair. The beam pair can be identified through a so-called beam management process in NR.

A DL beam is (typically) identified by an associated DL reference signal (RS) transmitted in the beam, either periodically, semi-persistently, or aperiodically. The DL RS for this purpose can be a Synchronization Signal (SS) and Physical Broadcast Channel (PBCH) block (SSB) or a Channel State Information RS (CSI-RS). By measuring all the DL RSs, the UE can determine and report to the gNB the best DL beam to use for DL transmissions. The gNB can then transmit a burst of different DL-RSs in the reported best DL beam to let the UE evaluate candidate UE RX beams.

Although not explicitly stated in the NR specification, beam management has been divided into three procedures, schematically illustrated in FIG. 1:
P-1: uses a wide gNB transmit (TX) beam covering a whole angular sector to find a coarse direction for the UE.
P-2: does a new beam search around the coarse direction found in P-1 to refine the gNB TX beam.
P-3: used for a UE that has analog beamforming to let the UE find a suitable UE RX beam.

P-1 is expected to utilize beams with rather large beamwidths where the beam reference signals are transmitted periodically and are shared between all UEs of the cell. Typically, the reference signals to use for P-1 are periodic CSI-RS or SSB. The UE then reports the N best beams to the gNB and the corresponding Reference Signal Received Power (RSRP) values for those beams.

P-2 is expected to use aperiodic/or semi-persistent CSI-RS transmitted in narrow beams around the coarse direction found in P-1.

P-3 is expected to use aperiodic/or semi-persistent CSI-RSs repeatedly transmitted in one narrow gNB beam. One alternative way is to let the UE determine a suitable UE RX beam based on the periodic SSB transmission. Since each SSB consists of four Orthogonal Frequency Division Multiplexing (OFDM) symbols, a maximum of four UE RX beams can be evaluated during each SSB burst transmission. One benefit with using SSB instead of CSI-RS is that no extra overhead of CSI-RS transmission is needed.

### Beam Indication

In NR, several signals can be transmitted from different antenna ports of a same base station. These signals can have the same large-scale properties such as Doppler shift/spread, average delay spread, or average delay. These antenna ports are then said to be quasi co-located (QCL).

If the UE knows that two of its antenna ports are QCL with respect to a certain parameter (e.g., Doppler spread), the UE can estimate that parameter based on one of the antenna ports and apply that estimate for receiving signal on the other antenna port.

For example, there may be a QCL relation between a CSI-RS for tracking reference signal (TRS) and the physical downlink shared channel (PDSCH) demodulation reference signal (DMRS). When the UE receives the PDSCH DMRS, the UE can use the measurements already made on the TRS to assist the DMRS reception.

Information about what assumptions can be made regarding QCL is signaled to the UE from the network. In NR, four types of QCL relations between a transmitted source RS and transmitted target RS were defined:
Type A: {Doppler shift, Doppler spread, average delay, delay spread}
Type B: {Doppler shift, Doppler spread}
Type C: {average delay, Doppler shift}
Type D: {Spatial RX parameter}

QCL type D was introduced in NR to facilitate beam management with analog beamforming and is known as spatial QCL. There is currently no strict definition of spatial QCL, but the understanding is that if two transmitted antenna ports are spatially QCL, the UE can use the same RX beam to receive them. This is helpful for a UE that uses analog beamforming to receive signals, since the UE needs to adjust its RX beam in some direction prior to receiving a certain signal. If the UE knows that the signal is spatially QCL with some other signal it has received earlier, then it can safely use the same RX beam to also receive this signal.

In NR, the spatial QCL relation for a DL or uplink (UL) signal/channel can be indicated to the UE by using a “beam indication.” The “beam indication” is used to help the UE to find a suitable RX beam for DL reception, and/or a suitable TX beam for UL transmission. In NR, the “beam indication” for DL is conveyed to the UE by indicating a transmission configuration indicator (TCI) state to the UE, while in UL the “beam indication” can be conveyed by indicating a DL-RS or UL-RS as spatial relation (in NR Rel-15/16) or a TCI state (in NR Rel-17).

### NR Sleep Modes

In NR, a UE can transition between three different states: disconnected/idle, (RRC connected) inactive, and (RRC) connected. For example, FIG. 2 illustrates RRC states according to TR 38.804. In both inactive and idle modes, the UE can be brought back to connected mode by the network with a paging message. In order to reduce the power, such paging messages are configured to only occur at certain times and with a determined periodicity, allowing the UE to assume a state of discontinuous reception (DRX) to save power. For idle mode, the UE uses the paging DRX cycle. For connected mode, a short DRX cycle and a long DRX cycle are specified with different tier such that the UE enters a longer DRX cycle subsequent to the expiration of the shorter DRX cycle for a more seamless transition from active to idle mode.

For an NCR, the term ON/OFF represents the above and possibly other modes for either the NCR-MT or the NCR-Fwd or both to reduce the power and interference according to the following objective:
Study and identify which side control information below is necessary for network-controlled repeaters including assumption of max transmission power [RAN1]
   . . .
   ON-OFF information for efficient interference management and improved energy efficiency

The Rel-18 NCR Work Item includes an objective to reduce network interference by using a default configuration that may configure the NCR-Fwd as OFF unless it is a time location in which the network node has instructed the NCR-Fwd to forward.

Unless stated otherwise, the terminology “repeater node” in this disclosure refers to a network-controlled repeater or a node with similar functionality, i.e., receiving a signal and instantaneously forwarding it in another direction.

### SUMMARY

There currently exist certain challenge(s). From an external point of view, two aspects of a repeater node include mobile termination (R-MT) and forwarding (R-Fwd). Because the R-MT has similar functionalities as a UE, most/all existing UE power saving features can be re-used for the R-MT, many of them related to OFF-states of UE (sub-)functions/operation. In particular, there exists a power saving framework based on RRC states active, inactive, and idle. In order to improve energy saving and/or interference management, it is also beneficial for the repeater node to control the ON/OFF behavior of the R-Fwd module. Considering that R-Fwd does not have any signal and channel awareness (a channel awareness that the R-MT can in principle have), the existing UE power saving functionalities (e.g., DRX functionality) is not suitable for R-Fwd. Hence, there is a need for methods to develop efficient signaling that is used by the gNB to control ON/OFF behavior of the R-Fwd.

Certain aspects of the disclosure and their embodiments may provide solutions to these or other challenges. A goal of this invention is to develop signaling exchange between a gNB controlling a repeater and an associated repeater node to enable the gNB to control the ON/OFF behavior of the R-Fwd. Thereby, the overall network performance can be improved by a better chance for energy saving and/or interference management. This addresses one of the main objectives of the Rel-18 study-item on network-controlled repeaters (RP-213700) regarding the control of repeater ON/OFF functionality.

Certain embodiments may provide one or more of the following technical advantage(s). Certain embodiments enable the gNB to control the repeater node ON/OFF functions. This enables appropriate ON/OFF procedure in repeater-assisted networks and addresses one of the key objectives of the 3GPP Release 18 study-item on NCRs. As a result, the repeater is properly integrated into the network, resulting in an improved network energy utilization and interference condition. Other advantages may be readily apparent to one having skill in the art. Certain embodiments may have none, some, or all of the recited advantages.

According to certain embodiments, a method is performed by a repeater node having an R-Fwd and an R-MT. The method comprises receiving a beam indication from a network node. The beam indication indicates one or more beams. The method further comprises configuring an ON/OFF status of the R-Fwd based at least in part on the beam indication.

According to certain embodiments, a repeater node comprises processing circuitry configured to: receive, from a network node, a beam indication that indicates one or more beams. The processing circuitry is further configured to configure an ON/OFF status of an R-Fwd of the repeater node based at least in part on the received beam indication.

According to certain embodiments, a method performed by a network node comprises determining a configuration for an ON/OFF status of an R-Fwd of a repeater node. The method further comprises sending the repeater node a beam indication that indicates one or more beams, the beam indication sent as an indication of the configuration for the ON/OFF status of the R-Fwd.

According to certain embodiments, a network node comprises processing circuitry. The processing circuitry is configured to determine a configuration for an ON/OFF status of an R-Fwd of a repeater node. The processing circuitry is further configured to send the repeater node a beam indication that indicates one or more beams, the beam indication sent as an indication of the configuration for the ON/OFF status of the R-Fwd.

### EXAMPLE REPEATER NODE EMBODIMENTS

Embodiment 1. A method in a repeater node for performing forwarding between a network node and a device, the repeater node associated with the network node and the repeater node comprising R-MT and R-Fwd functions, the method comprising: (1a) receiving one or multiple configuration messages from the network node; (1b) determining a mode of operation for the R-Fwd according to the received configuration message(s) and timer type(s); and (1c) configuring the R-Fwd ON/OFF according to the determined mode of operation.

Embodiment 2. The method of the preceding embodiment, wherein prior to receiving the one or multiple configuration messages in (1a), the method further comprises sending a capability report from the repeater node to the network node, the capability report including one or more capabilities such as: (2a) function as a repeater; (2b) beam arrangement report; (2c) R-Fwd's reliance on R-MT; (2d) ON/OFF capability; (2e) latency requirements for dynamic indication; or (2f) power allocation capability.

Embodiment 3. The method of any of the preceding embodiments, wherein prior to determining the mode of operation in (1b), the method further comprises determining a timer expiration.

Embodiment 4. The method of any of the preceding embodiments, wherein the one or multiple configuration messages in (1a) indicate one or multiple configurations, the one or multiple configurations including one or more of: (4a) a (connected, inactive, and idle mode) DRX configuration for the R-MT; (4b) an ON/OFF configuration for R-Fwd; or (4c) a joint ON/OFF configuration for both R-MT and R-Fwd.

Embodiment 5. The method of any of the preceding embodiments, wherein the one or multiple configuration messages in (1a) indicate one or multiple configurations and the one or multiple of configurations can be configured: (5a) independently; or (5b) jointly.

Embodiment 6. The method of any of the preceding embodiments, wherein the one or multiple configuration messages in (1a) indicate one or multiple configurations, the one or multiple configurations including an ON/OFF configuration for R-Fwd, wherein the ON/OFF configuration for R-Fwd comprises one or more of: (6a) OFF state is default; (6b) jointly configured with repeater node beam indication; (6c) jointly configured with repeater node power control; (6d) jointly configured with the R-MT's DRX mode; or (6e) associated to DL/UL transmission direction.

Embodiment 7. The method of any of the preceding embodiments, wherein the one or multiple configuration messages in (1a) indicate one or multiple configurations, the one or multiple configurations including an ON/OFF configuration for R-Fwd, wherein the ON/OFF configuration for R-Fwd applies to: (7a) entire R-Fwd bandwidth; or (7b) one or multiple of R-Fwd sub-bands.

Embodiment 8. The method of any of the preceding embodiments, wherein the one or multiple configuration messages in (1a) indicate one or multiple configurations, the one or multiple configurations including a joint ON/OFF configuration for R-MT and R-Fwd, wherein the joint ON/OFF configuration for R-MT and R-Fwd comprises one or more of: (8a) adapting the legacy power saving functionality with a flag indicating whether configuration applies to R-MT, R-Fwd, or both; (8b) wake-up signaling from the network node; or (8c) wake-up signaling from the device.

Embodiment 9. The method of any of the preceding embodiments, wherein the one or multiple configuration messages in (1a) indicate one or multiple configurations, wherein the one or multiple of configurations can be one or more of: (9a) semi-static configuration; (9b) semi-persistent configuration; or (9c) dynamic configuration.

Embodiment 10. The method of any of the preceding embodiments, wherein the one or multiple configuration messages in (1a) indicate one or multiple ON/OFF configurations, and wherein the one or multiple ON/OFF configurations are associated to a priority.

Embodiment 11. The method of any of the preceding embodiments, wherein determining the mode of operation in (1b) can be based on one or more of: (11a) the priority from embodiment 10; or (11b) pre-defined rules in a specification.

Embodiment 12. The method of any of the preceding embodiments, wherein configuring the R-Fwd ON/OFF according to the determined mode of operation in (1c) comprises configuring the R-Fwd according to one or more of: (12a) an ON/OFF configuration provided to R-Fwd; (12b) an ON/OFF configuration provided to R-MT; (12c) a joint ON/OFF configuration for both R-MT and R-Fwd; or (12d) a status of one or more timer(s).

Embodiment 13. The method of any of the preceding embodiments, wherein the repeater node may perform one or more of: (13a) power ON/OFF R-Fwd according to a configuration provided to R-Fwd; (13b) power ON/OFF R-Fwd according to a configuration provided to R-MT; or (13c) power ON/OFF R-MT and/or R-Fwd according to an associated priority.

Embodiment 14. The method of any of the preceding embodiments, the method further comprises determining a timer expiration, and wherein, depending on an expired timer type associated with the timer expiration, the R-Fwd is configured: (14a) to only forward according to its semi-static configuration, or (14b) to not forward.

Embodiment 15. The method of the preceding embodiment, wherein types of timers may be one or more of: (15a) a short C-DRX timer; or (15b) a long C-DRX timer.

Embodiment 16. The method of any of the preceding embodiments, wherein the repeater node is a network-controlled repeater or a node with similar functionalities.

### EXAMPLE WIRELESS NETWORK NODE EMBODIMENTS (MIRRORING THE ABOVE EMBODIMENTS)

Embodiment 1. A method in a wireless network node for configuring a repeater node for performing forwarding between a network node and a device, the method comprising: (1a) determining one or multiple configurations of ON/OFF for the repeater node; and (1b) signaling the one or multiple of configurations to the repeater node.

Embodiment 2. The method of the preceding embodiment, wherein prior to (1a) the network node may receive a capability report including one or more capabilities such as: (2a) function as a repeater; (2b) beam arrangement report; (2c) R-Fwd's reliance on R-MT; (2d) ON/OFF capability; (2e) latency requirements for dynamic indication; or (2f) power allocation capability.

Embodiment 3. The method of any of the preceding embodiments, wherein the one or multiple configurations comprise one or more of: (3a) a (connected, inactive and idle mode) DRX configuration for the R-MT; (3b) an ON/OFF configuration for R-Fwd; or (3c) a joint ON/OFF configuration for both R-MT and R-Fwd.

Embodiment 4. The method of any of the preceding embodiments, wherein the one or multiple configurations determined in (1a) can be configured: (4a) independently; or (4b) jointly.

Embodiment 5. The method of any of the preceding embodiments, wherein the one or multiple configurations determined in (1a) can be one or more of: (5a) semi-static configuration; (5b) semi-persistent configuration; or (5c) dynamic configuration.

Embodiment 6. The method of any of the preceding embodiments, wherein the one or multiple configurations determined in (1a) is determined based on one or more of: (6a) repeater node's ON/OFF capabilities; (6b) R-Fwd's reliance on R-MT; (6c) reported latency requirements; or (6d) a need (e.g., traffic condition, data buffer, interference level, etc.).

Embodiment 7. The method of any of the preceding embodiments, wherein at least one of the one or multiple configurations determined in (1a) is associated to a priority.

Embodiment 8. The method of any of the preceding embodiments, wherein the one or multiple configurations comprise an ON/OFF configuration for R-Fwd, and wherein the ON/OFF configuration for R-Fwd comprises one or more of: (8a) OFF state is default; (8b) jointly configured with repeater node beam indication; (8c) jointly configured with repeater node power control; (8d) jointly configured with the R-MT's DRX mode; or (8e) associated to DL/UL transmission direction.

Embodiment 9. The method of any of the preceding embodiments, wherein the one or multiple configurations comprise an ON/OFF configuration for R-Fwd, and wherein the ON/OFF configuration for R-Fwd applies to: (9a) entire R-Fwd bandwidth; or (9b) one or multiple of repeater Fwd sub-bands.

Embodiment 10. The method of any of the preceding embodiments, wherein the one or multiple configurations comprise a joint ON/OFF configuration for both R-MT and R-Fwd, and wherein the joint ON/OFF configuration for R-MT and R-Fwd comprises one or more of: (10a) adapting the legacy power saving functionality with a flag indicating whether configuration applies to R-MT, R-Fwd, or both; (10b) wake-up signaling from the network node; or (10c) wake-up signaling from the device.

Embodiment 11. The method of any of the preceding embodiments, wherein signaling the one or multiple of configurations to the repeater node in (1b) comprises signaling the one or multiple configurations via one or more of: (11a) Radio Resource Control (RRC); (11b) Medium Access Control-Control Element (MAC-CE); (11c) Downlink Control Information (DCI); or (11d) System Information (SI).

Embodiment 12. The method of any of the preceding embodiments, wherein the repeater node is a network-controlled repeater or a node with similar functionalities.

### BRIEF DESCRIPTION OF THE FIGURES

For a more complete understanding of the disclosed embodiments and their features and advantages, reference is now made to the drawings, in which:

FIG. 1 illustrates an example of a beam management procedure.

FIG. 2 illustrates an example of radio resource control (RRC) states.

FIG. 3 illustrates an example of how a network-controlled repeater (NCR) may communicate with a network in accordance with some embodiments.

FIG. 4 illustrates an example block diagram of a network-controlled repeater and how it may communicate with a network in accordance with some embodiments.

FIG. 5 illustrates an example of using beamforming in a repeater-assisted network.

FIG. 6 illustrates an example of a method performed by a repeater in accordance with some embodiments. The box with the dashed line represents an optional step.

FIG. 7 illustrates an example of a method performed by a network node in accordance with some embodiments. The box with the dashed line represents an optional step.

FIG. 8 shows an example of a communication system in accordance with some embodiments.

FIG. 9 shows an example of a user equipment (UE) in accordance with some embodiments.

FIG. 10 shows an example of a network node in accordance with some embodiments.

FIG. 11 shows an example of a host in accordance with some embodiments.

FIG. 12 shows an example of a virtualization environment in accordance with some embodiments.

FIG. 13 shows an example of a host communicating with a UE via a network node in accordance with some embodiments.

FIG. 14 illustrates an example of a method performed by a repeater node in accordance with some embodiments.

FIG. 15 illustrates an example of a method performed by a wireless network node in accordance with some embodiments.

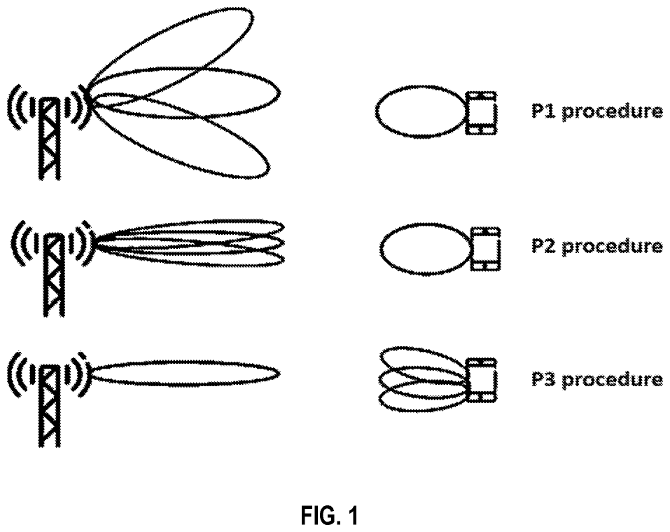

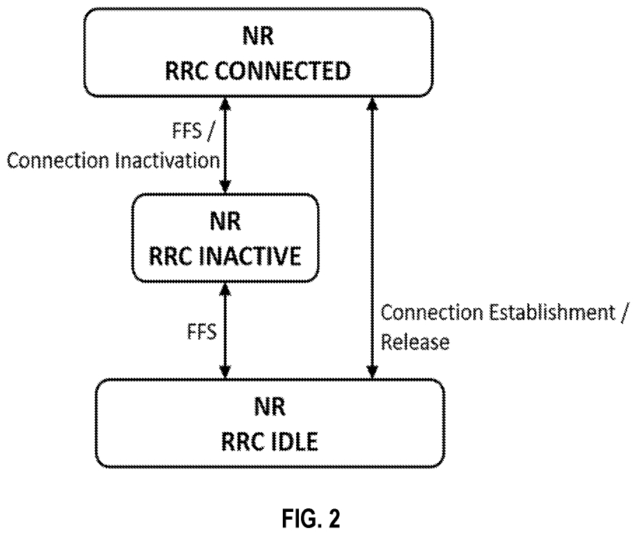

### DETAILED DESCRIPTION

Some of the embodiments contemplated herein will now be described more fully with reference to the accompanying drawings. Embodiments are provided by way of example to convey the scope of the subject matter to those skilled in the art.

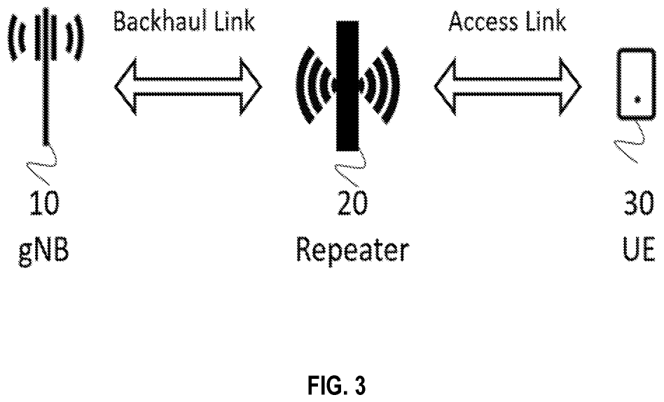

FIG. 3 gives an example deployment for a repeater node 20. As an example, repeater node 20 may be an NCR or a node with similar functionalities. In the deployment shown in FIG. 3, repeater node 20 may communicate with a gNB 10 via a wireless connection referred to as a backhaul link. Repeater node 20 may communicate with a UE 30 via a wireless connection referred to as an access link.

In one alternative, repeater node 20 can be a normal repeater with beamforming capabilities. In this way, repeater node 20 may be considered as a network-controlled “beam bender” when compared to a gNB. As such, it is logically part of the gNB 10 for management purposes, i.e., it is likely that repeater node 20 is deployed and under the control of the operator. Certain embodiments of the repeater node 20 shown in FIG. 3 may be based on an amplify-and-forward relaying scheme, and repeater node 20 may be limited to single-hop communication in stationary deployments with the focus on FR2 in certain embodiments.

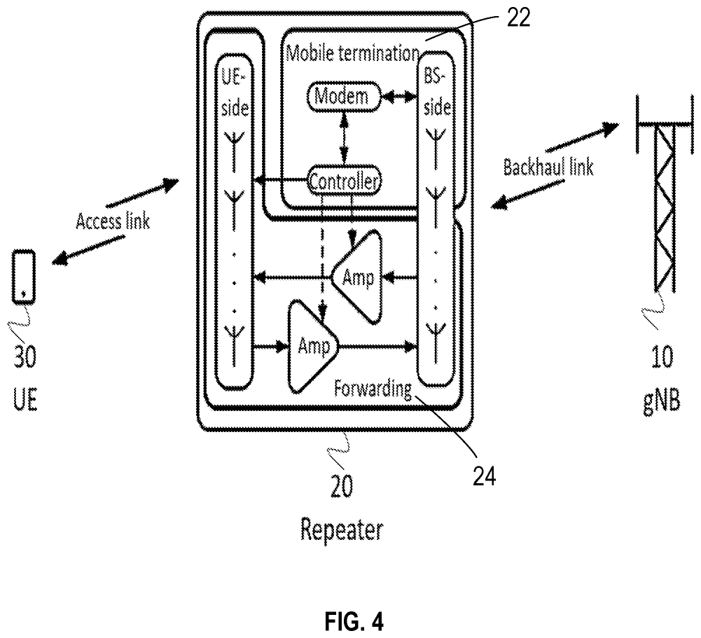

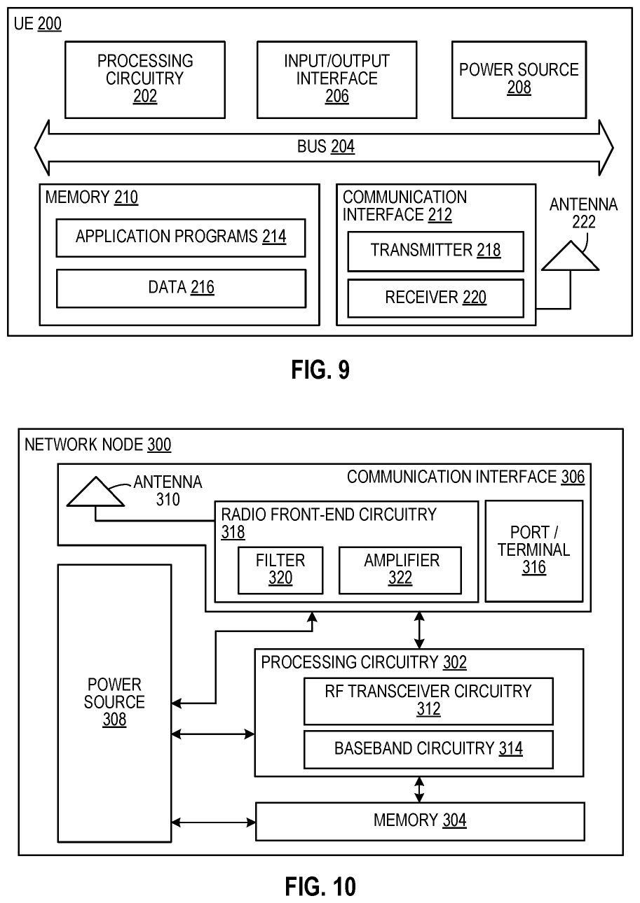

FIG. 4 illustrates one schematic example of how repeater node 20 (e.g., an NCR) may be designed and how it may communicate with the network. Note that while FIG. 4 illustrates a possible structure for repeater node 20, other structures are possible. In the example shown in FIG. 4, repeater node 20 comprises a mobile termination 22 (R-MT) and a forwarder 24 (R-Fwd). Certain embodiments may implement the R-MT and R-Fwd using processing circuitry. The processing circuitry may comprise one or more processors and, in general, may be analogous to processing circuitry 202 or processing circuitry 302 described below for FIG. 9 and FIG. 10, respectively. In the example of FIG. 4, repeater node 20 includes three principal building blocks: a Modem, a Controller module, and a Repeater module (depicted as the two amplifiers in FIG. 4). Both the Modem module and the Controller module can be part of the R-MT in repeater node 20. The Repeater module can be part of the R-Fwd in repeater node 20.

In the example illustrated in FIG. 4, repeater node 20 is equipped with an antenna configuration where a signal may be received in the downlink and, e.g., after power amplification, may be transmitted further in the downlink. For example, the signal may be received from gNB 10 in the downlink and transmitted further to UE 30 in the downlink. Similarly, a signal may be received in the uplink and, e.g., after power amplification, may be transmitted further in the uplink. For example, the signal may be received from UE 30 in the uplink and transmitted further to gNB 10 in the uplink. In certain embodiments, the Repeater module only amplifies and (analogously) beamforms the signal, so that no advanced receiver or transmitter chains are required, which reduces the cost and energy consumption compared to, for example, a normal Transmission and Reception Point (TRP). In its simplest architecture, repeater node 20 uses different antenna modules for the donor side (the antennas targeting the gNB 10) and the service sides (the antennas targeting one or more UEs 30). A more complex architecture, including self-interference cancellation, would allow for using the same antenna modules for both sides.

The Modem module is able and used to exchange control and status signaling with a gNB 10 that is controlling repeater node 20. For this, the Modem module supports at least a sub-set of UE functions. Repeater control and status information (such as NCR control and status information) is further exchanged between the Modem module and the Controller module. The Modem module might be equipped with antennae separated from the antennae used by the Repeater module; but in most configurations, the Modem module and Repeater module will share antenna configurations.

The Controller module is used to control the Repeater module, for example, by providing beamforming information, power control information, etc. The Controller module is connected to the network through the Modem module such that the network can control the Controller module and, in that way, control the Repeater module.

The Repeater module's amplify-and-forward operation is controlled by the Controller module. The Controller module could also be directly responsible for the beamforming control on the service antenna side, i.e., to/from served UEs 30. In an alternative, the beamforming on the service antenna side is operated by the Repeater module under control of the Controller module. On the donor antenna side, i.e., to/from the controlling gNB 10, the Modem module could be directly responsible for the beamforming control. In an alternative, the beamforming on the service antenna side is operated by the Repeater module under control of the Controller module and/or Modem module.

In one configuration, the Modem module and the Repeater module do not only share an antenna configuration but also parts of the (analog) transmitter and/or receiver, such as power (transmit) amplifier and/or receiver amplifiers and/or filters.

The Modem module and the Repeater module could be operating at the same or different frequencies. For example, the Repeater module could operate at a high frequency band (e.g., FR2) and the Modem module could be operating at a low frequency band (e.g., FR1).

FIG. 5 illustrates an example of a repeater-assisted network. As depicted in FIG. 5, the system model considers a source node (e.g., gNB 10) communicating with one or more destination nodes (e.g., UEs 30) in wireless communication links that are relayed by one or more repeater nodes (e.g., repeater node 20, which is shown as a network-controlled repeater in the example of FIG. 5). In particular, FIG. 5 illustrates beam-based communication. In the example shown in FIG. 5, gNB 10 transmits a plurality of gNB TX beams (including, for example, gNB TX beams 0, i, and x); repeater node 20 receives communications from gNB 10 via an NCR RX beam; repeater node 20 transmits a plurality of NCR TX beams (including, for example, NCR TX beams 0, i, and y); and UE 30 receives communications from repeater node 20 via a UE RX beam. A beam management system may keep track of suitable beams for transmission and reception at the network node (e.g., gNB 10), repeater node 20, and UE 30.

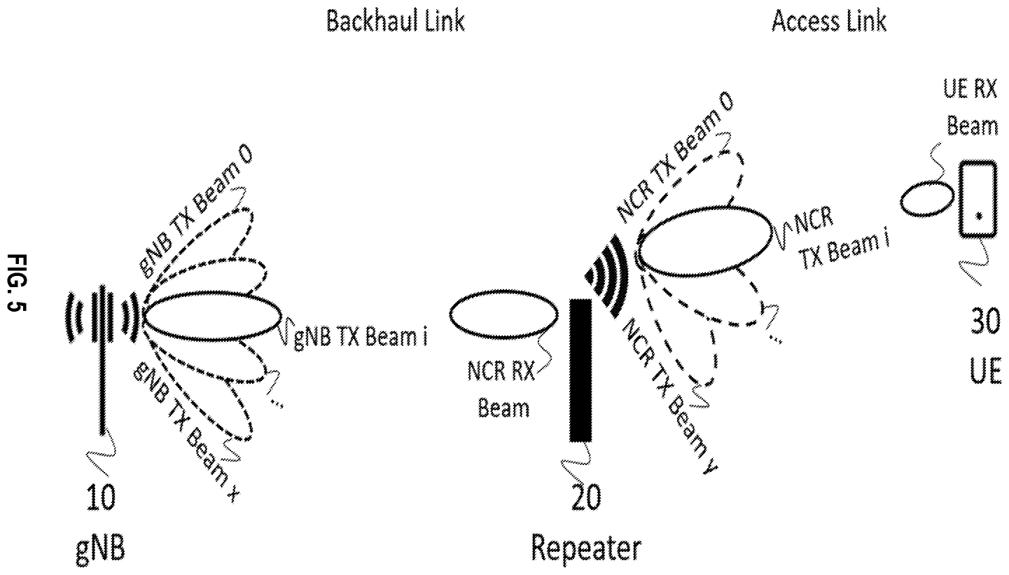

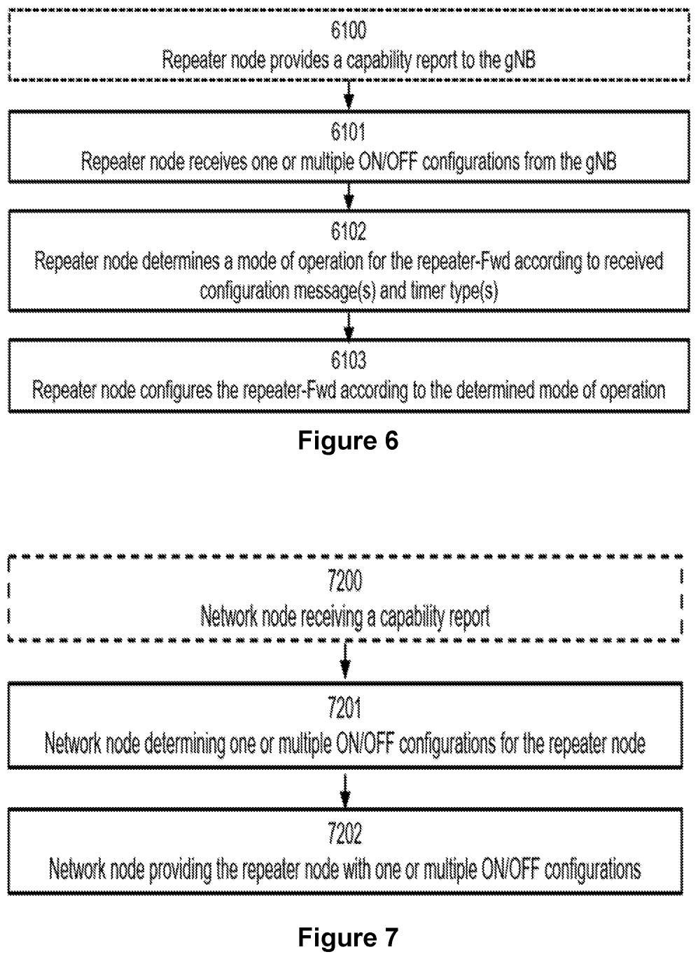

FIG. 6 depicts the flowchart for the repeater node aspect of the invention. For example, the operations illustrated in FIG. 6 may be performed by repeater node 20 described above.

In an optional first operation (6100), the repeater node provides a capability report to the gNB.

In one embodiment, the capability report may comprise a repeater beam arrangement report, containing repeater beam capabilities and beam information for each sub-band, regarding one or more of:
Size of antenna sub-plane (X-by-Y) and/or number of fundamental (Fast Fourier transform, FFT) beams (X-by-Y);
A beam hierarchy, for example, beam constellation (horizontal X-axis by vertical Y-axis, or relative position to bore sight, etc.) for beam hierarchy level, and/or beam configuration for lower beam hierarchy level, e.g., a set of M by N beams for, say, every beam of the higher beam hierarchy;
Number of beams of each type of beam (for example different types of beams have different beamwidths). The number of beams can be reported as number of vertical beams and number of horizontal beams (which will mean that the total number of beams of a certain type of beams would be equal to “number of horizontal beams”*“number of vertical beams,” assuming a rectangular discrete Fourier transform (DFT) beam grid);
Polarization of the beam;
Beam expansion capability, including possible limitations in the beam expansion capability.

Note that the “beam arrangement report” can consist of several different parts where each part can contain different information, for example, as listed above.

In one embodiment, the repeater node can report its ON/OFF capabilities to the network node. For example, the repeater node can report to the network node information regarding the reliance between its R-Fwd and R-MT modules. It may be beneficial to consider individual ON/OFF operation and signaling for R-MT and R-Fwd to provide flexibility for better energy saving and interference management. Considering the R-Fwd's reliance on the R-MT, ON/OFF of the R-Fwd may depend on the R-MT's RRC state and ON/OFF status, see Table 1 below. Generally speaking, for the case where the R-MT is in ON periods, the R-Fwd can follow any configuration or indication as configured to R-Fwd, received via R-MT. For the case where the R-MT is configured in OFF periods, or RRC_inactive or RRC_idle mode, the R-Fwd may have different behaviors depending on the repeater implementation. In one example, the R-Fwd can follow its received semi-static configurations, in other words R-Fwd is functioning when R-MT is OFF. In another example, the R-Fwd will need to follow the configuration of R-MT and enter the sleep mode, in other words, the R-Fwd is not functioning when R-MT is OFF.

TABLE 1
Relation between R-MT's RRC state
and R-Fwd's ON/OFF behavior.

| | R-MT in | R-MT in RRC_INACTIVE |
|---|---|---|
| | RRC_CONNECTED | or RRC_IDLE |
| R-Fwd | R-Fwd follows its semi- | Option 1. R-Fwd follows its |
| ON/OFF | static configuration | semi-static configuration. |
| | and/or dynamic indication. | or |
| | | Option 2. R-Fwd follows the |
| | | MT's RRC state. |

In one embodiment, the reliance information between R-MT and R-Fwd can be obtained from the specification. In one example, the specification may require the R-Fwd to shut down when the R-MT is in the sleep periods.

In one embodiment, the repeater node can report its latency requirements for dynamic indication, e.g., the decoding time for a dynamic indication, etc.

In one embodiment, the repeater node can report its power allocation capabilities to the network node.

In one detailed embodiment, the signaling of capability report can use, e.g., RRC, MAC-CE, etc. In another embodiment the gNB can obtain the repeater capabilities from, e.g., Operations, Administration and Maintenance (OAM), gNB-Central Unit (gNB-CU), etc.

In operation (6101), the repeater node receives one or multiple ON/OFF configurations from the gNB. Here, the one or multiple ON/OFF configurations, for R-MT and/or R-Fwd, can be configured independently or jointly.

In one embodiment, the repeater node can be provided with individual ON/OFF configurations for the R-MT and R-Fwd.

In an alternative embodiment, the R-MT and R-Fwd can be provided with one joint ON/OFF configuration. In one detailed embodiment, the joint ON/OFF configuration can be based on adapting the legacy UE power saving functionalities with a flag which indicates if the configuration applies to the R-MT, the R-Fwd, or both. In a further embodiment, the repeater node may receive wake-up signals, for example, from the network node and/or the device. The wake-up signals can be legacy wake-up signals or new repeater node specific wake-up signals.

In one embodiment, the ON/OFF configuration configured to R-Fwd can assume “OFF”-state is default. In another related embodiment, the R-Fwd specific ON/OFF configuration (only applies to R-Fwd) can be related to one or multiple other R-Fwd configurations, e.g., beam indication, power control, etc. In one example, OFF signaling is mutually exclusive from R-Fwd beam indication in the sense that no beam needs to be configured if R-Fwd is configured OFF and vice versa. In this case, OFF can be viewed as a special state of the beam configuration, e.g., as a NULL beam.

In another embodiment, the R-Fwd ON/OFF configuration may be jointly configured with the R-MT's DRX mode.

In one embodiment, the R-Fwd ON/OFF configuration may be associated with DL/UL transmission direction.

In one embodiment, an R-Fwd specific ON/OFF configuration can be provided for the entire configured R-Fwd bandwidth, or only for one or multiple sub-bands of the R-Fwd.

In one detailed embodiment, the repeater node can be provided with semi-static and/or semi-persistent, and/or dynamic ON/OFF configurations.

In one embodiment, the R-Fwd module does not have signal and channel awareness. In this case, the R-Fwd specific ON/OFF configuration is provided to the R-MT without relying on any signal and channel awareness.

In another embodiment, the one or multiple of ON/OFF configurations may be associated to a priority.

In operation (6102), the repeater node determines the ON/OFF configurations based on the received configuration messages and the timer type(s).

In one embodiment, subsequent to operation (6101), the repeater node may determine that a timer has expired. The timer may be a short C-DRX timer or a long C-DRX timer. In a related embodiment, the repeater may be configured, depending on the timer type:
to only forward according to the repeater's semi-static configuration, or
to not forward at all.

For example, the repeater may be configured to only forward according to its semi-static configuration following the expiration of the short C-DRX timer and not to forward at all following the expiration of the long C-DRX timer.

In one embodiment, the repeater node determines the R-Fwd ON/OFF configuration based on the RRC state and/or ON/OFF status of the R-MT. When the R-MT is in the ON periods, the R-Fwd can receive dynamic ON/OFF configuration. When the R-MT is in the OFF periods, or RRC_idle, or RRC_inactive, depending on the reported reliance information (i.e., whether the R-Fwd can function without R-MT is ON), the R-Fwd may apply the received semi-static ON/OFF configuration, or following the configuration of the R-MT. In one detailed embodiment, along applying the semi-static ON/OFF configuration, the R-Fwd may perform forwarding of semi-statically configured periodic cell-common signals and channels.

In one embodiment, the repeater node determines the ON/OFF configuration for R-Fwd according to the associated priority.

In one embodiment, the repeater node determines the ON/OFF configuration for R-Fwd based on pre-defined rules.

In one embodiment, the repeater node determines the ON/OFF configuration for R-Fwd according to the rules in the specification.

In operation (6103), the repeater node configures the R-Fwd according to the determined ON/OFF configurations from the operation (6102).

In one embodiment, the R-Fwd is configured according to the determined ON/OFF configuration provided to R-Fwd.

In one embodiment, the R-Fwd is configured ON/OFF according to the determined ON/OFF configuration provided to R-MT.

In one embodiment, the repeater powers ON/OFF R-Fwd according to the configuration provided to R-Fwd.

In one embodiment, the repeater powers ON/OFF R-Fwd according to the configuration provided to the R-MT.

In one embodiment, the repeater powers ON/OFF R-Fwd and/or R-MT according to the associated priority.

In one embodiment, the repeater node monitors the wake-up signal from e.g., the network node, and/or the device.

In this way, the proposed scheme enables the integration of the network-controlled repeaters into the network and improves the coverage extension of the serving cell.

### Network Node Aspects of the Invention

FIG. 7 depicts the flowchart for the network node aspect of the invention. For example, the operations illustrated in FIG. 7 may be performed by gNB 10 described above.

In an optional first operation (7200), the network node receives a capability report from the repeater node.

In one embodiment, the capability report may comprise a repeater beam arrangement report, containing repeater beam capabilities and beam information for each sub-band, regarding one or more of:
Size of antenna sub-plane (X-by-Y) and/or number of fundamental (FFT) beams (X-by-Y);
A beam hierarchy, for example beam constellation (horizontal X-axis by vertical Y-axis, or relative position to bore sight etc.) for beam hierarchy level, and or beam configuration for lower beam hierarchy level, e.g., a set of M by N beams for, say, every beam of the higher beam hierarchy;
Number of beams of each type of beam (for example different types of beams have different beamwidths). The number of beams can be reported as number of vertical beams, and number of horizontal beams (which will mean that the total number of beams of a certain type of beams would be equal to “number of horizontal beams”*“number of vertical beams,” assuming a rectangular DFT beam grid);
Polarization of the beam;
Beam expansion capability, including possible limitations in the beam expansion capability.

In one embodiment, the network node can receive from the repeater node information regarding the reliance between its R-Fwd and R-MT. It may be beneficial to consider individual ON/OFF operation and signaling for R-MT and R-Fwd to provide flexibility for better energy saving and interference management. Considering the R-Fwd's reliance on the R-MT, ON/OFF of the R-Fwd may depend on the R-MT's RRC state and ON/OFF status, see Table 1 above. Generally speaking, for the case where the R-MT is in ON periods, the R-Fwd can follow any configuration or indication as configured to R-Fwd, received via R-MT. For the case where the R-MT is configured in OFF periods, or RRC_inactive or RRC_idle mode, the R-Fwd may have different behaviors depending on the repeater implementation. In one example, the R-Fwd can follow its received semi-static configurations, in other words R-Fwd is functioning when R-MT is OFF. In another example, the R-Fwd will need to follow the configuration of R-MT and enter the sleep mode, in other words, the R-Fwd is not functioning when R-MT is OFF.

In one embodiment, the network node receives from the repeater node information on repeater node's ON/OFF capabilities.

In one embodiment, the network node receives from the repeater node information on latency requirements for dynamic indication, e.g., the decoding time for a dynamic indication etc.

In one embodiment, the network node may receive from the repeater node information about the repeater node's power allocation capabilities.

In one detailed embodiment the signaling of capability report can use, e.g., RRC, MAC-CE, etc. In another embodiment the network node can obtain the repeater node's capabilities, for example, from OAM, gNB-CU, etc.

In operation (7201), the network node determines one or multiple of ON/OFF configurations for the repeater node.

In one embodiment, the R-MT and R-Fwd can be configured with individual ON/OFF configurations. In one detailed embodiment, the two separate configurations are configured independently. In another detailed embodiment, the two separate configurations are configured jointly.

In an alternative embodiment, the R-MT and the R-Fwd can be configured with one joint ON/OFF configuration. In one detailed embodiment, the joint ON/OFF configuration can be based on adapting the legacy UE power saving functionalities. A flag may be provided to indicate if the configuration applies to the R-MT, the R-Fwd, or both. In a further embodiment, the repeater node may receive wake-up signals, for example, from the network node and/or from the device.

In one embodiment, the ON/OFF configuration configured to R-Fwd can assume “OFF”-state is default. In another related embodiment, the R-Fwd specific ON/OFF configuration can be related to one or multiple of other R-Fwd configurations, e.g., beam indication, power control etc. In one example, OFF signaling is mutually exclusive from R-Fwd beam indication in the sense that no beam needs to be configured if the R-Fwd is configured OFF and vice versa. In this case, OFF can be viewed as a special state of the beam configuration, e.g., as a NULL beam.

In one embodiment, the R-Fwd specific ON/OFF configuration can be provided for the entire configured R-Fwd bandwidth, or one or multiple of sub-bands of the R-Fwd.

In one embodiment, the one or multiple of ON/OFF configurations are configured based on a need, such as traffic condition in the network, data buffer, past usage, interference level in the network, etc. In another embodiment, the ON/OFF configuration can also be configured based on a need of forwarding cell-common signals and channels between the network node and the device. In one detailed embodiment, the said need can be different for the UL and DL directions, respectively, thereby the ON/OFF configuration is associated to UL/DL transmission direction.

In one embodiment, the one or multiple of ON/OFF configurations are associated to a priority. The network node can determine the priority based on a need, such as traffic condition in the network, interference level in the network etc. In another example, the network node can determine the priority based on a need of forwarding cell-common signals and channels between the network node and the device.

In operation (7202), the network node signals the said one or multiple of ON/OFF configurations to the repeater node.

In one embodiment, the repeater can be provided with semi-static and/or semi-persistent, and/or dynamic ON/OFF configurations.

In one embodiment, the one or multiple of ON/OFF configurations are conveyed to the repeater node via e.g., RRC, and/or MAC-CE, and/or DCI, and/or System Information etc.

In one embodiment, the R-Fwd module does not have signal and channel awareness. In this case, the R-Fwd ON/OFF configuration is provided to the R-MT without relying on any signal and channel awareness.

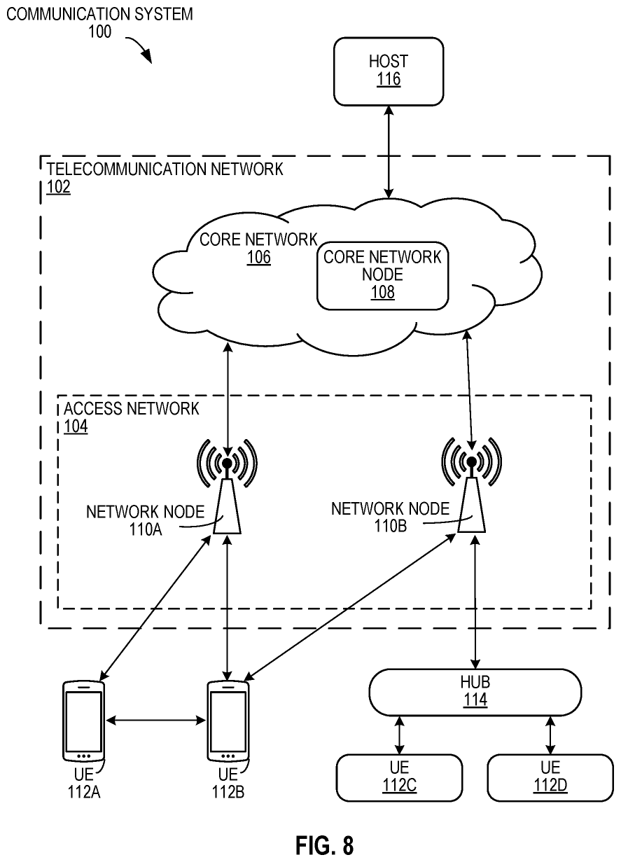

FIG. 8 shows an example of a communication system 100 in accordance with some embodiments.

In the example, the communication system 100 includes a telecommunication network 102 that includes an access network 104, such as a radio access network (RAN), and a core network 106, which includes one or more core network nodes 108. The access network 104 includes one or more access network nodes, such as network nodes 110a and 110b (one or more of which may be generally referred to as network nodes 110), or any other similar 3^{rd} Generation Partnership Project (3GPP) access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network 102 includes one or more Open-RAN (ORAN) network nodes. An ORAN network node is a node in the telecommunication network 102 that supports an ORAN specification (e.g., a specification published by the O-RAN Alliance, or any similar organization) and may operate alone or together with other nodes to implement one or more functionalities of any node in the telecommunication network 102, including one or more network nodes 110 and/or core network nodes 108.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes 110 facilitate direct or indirect connection of user equipment (UE), such as by connecting UEs 112a, 112b, 112c, and 112d (one or more of which may be generally referred to as UEs 112) to the core network 106 over one or more wireless connections. A network node 110 may be configured to act as a network-controlled repeater node as described herein.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 100 may include any number of wired or wireless networks, network nodes, UEs, and/or any other components or systems that may facilitate or participate in the communication of data and/or signals whether via wired or wireless connections. The communication system 100 may include and/or interface with any type of communication, telecommunication, data, cellular, radio network, and/or other similar type of system.

The UEs 112 may be any of a wide variety of communication devices, including wireless devices arranged, configured, and/or operable to communicate wirelessly with the network nodes 110 and other communication devices. Similarly, the network nodes 110 are arranged, capable, configured, and/or operable to communicate directly or indirectly with the UEs 112 and/or with other network nodes or equipment in the telecommunication network 102 to enable and/or provide network access, such as wireless network access, and/or to perform other functions, such as administration in the telecommunication network 102.

In the depicted example, the core network 106 connects the network nodes 110 to one or more hosts, such as host 116. These connections may be direct or indirect via one or more intermediary networks or devices. In other examples, network nodes may be directly coupled to hosts. The core network 106 includes one more core network nodes (e.g., core network node 108) that are structured with hardware and software components. Features of these components may be substantially similar to those described with respect to the UEs, network nodes, and/or hosts, such that the descriptions thereof are generally applicable to the corresponding components of the core network node 108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 116 may be under the ownership or control of a service provider other than an operator or provider of the access network 104 and/or the telecommunication network 102, and may be operated by the service provider or on behalf of the service provider. The host 116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 100 of FIG. 8 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 102 is a cellular network that implements 3GPP standardized features. Accordingly, the telecommunications network 102 may support network slicing to provide different logical networks to different devices that are connected to the telecommunication network 102. For example, the telecommunications network 102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 112 are configured to transmit and/or receive information without direct human interaction. For instance, a UE may be designed to transmit information to the access network 104 on a predetermined schedule, when triggered by an internal or external event, or in response to requests from the access network 104. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, the hub 114 communicates with the access network 104 to facilitate indirect communication between one or more UEs (e.g., UE 112c and/or 112d) and network nodes (e.g., network node 110b). In some examples, the hub 114 may be a controller, router, content source and analytics, or any of the other communication devices described herein regarding UEs. For example, the hub 114 may be a broadband router enabling access to the core network 106 for the UEs. As another example, the hub 114 may be a controller that sends commands or instructions to one or more actuators in the UEs. Commands or instructions may be received from the UEs, network nodes 110, or by executable code, script, process, or other instructions in the hub 114. As another example, the hub 114 may be a data collector that acts as temporary storage for UE data and, in some embodiments, may perform analysis or other processing of the data. As another example, the hub 114 may be a content source. For example, for a UE that is a VR headset, display, loudspeaker or other media delivery device, the hub 114 may retrieve VR assets, video, audio, or other media or data related to sensory information via a network node, which the hub 114 then provides to the UE either directly, after performing local processing, and/or after adding additional local content. In still another example, the hub 114 acts as a proxy server or orchestrator for the UEs, in particular if one or more of the UEs are low energy IoT devices.

The hub 114 may have a constant/persistent or intermittent connection to the network node 110b. The hub 114 may also allow for a different communication scheme and/or schedule between the hub 114 and UEs (e.g., UE 112c and/or 112d), and between the hub 114 and the core network 106. In other examples, the hub 114 is connected to the core network 106 and/or one or more UEs via a wired connection. Moreover, the hub 114 may be configured to connect to an M2M service provider over the access network 104 and/or to another UE over a direct connection. In some scenarios, UEs may establish a wireless connection with the network nodes 110 while still connected via the hub 114 via a wired or wireless connection. In some embodiments, the hub 114 may be a dedicated hub—that is, a hub whose primary function is to route communications to/from the UEs from/to the network node 110b. In other embodiments, the hub 114 may be a non-dedicated hub—that is, a device which is capable of operating to route communications between the UEs and network node 110b, but which is additionally capable of operating as a communication start and/or end point for certain data channels.

FIG. 9 shows a UE 200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 200 includes processing circuitry 202 that is operatively coupled via a bus 204 to an input/output interface 206, a power source 208, a memory 210, a communication interface 212, and/or any other component, or any combination thereof. Certain UEs may utilize all or a subset of the components shown in FIG. 9. The level of integration between the components may vary from one UE to another UE. Further, certain UEs may contain multiple instances of a component, such as multiple processors, memories, transceivers, transmitters, receivers, etc.

The processing circuitry 202 is configured to process instructions and data and may be configured to implement any sequential state machine operative to execute instructions stored as machine-readable computer programs in the memory 210. The processing circuitry 202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 202 may include multiple central processing units (CPUs).

In the example, the input/output interface 206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 208 is structured as a battery or battery pack. Other types of power sources, such as an external power source (e.g., an electricity outlet), photovoltaic device, or power cell, may be used. The power source 208 may further include power circuitry for delivering power from the power source 208 itself, and/or an external power source, to the various parts of the UE 200 via input circuitry or an interface such as an electrical power cable. Delivering power may be, for example, for charging of the power source 208. Power circuitry may perform any formatting, converting, or other modification to the power from the power source 208 to make the power suitable for the respective components of the UE 200 to which power is supplied.

The memory 210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 210 includes one or more application programs 214, such as an operating system, web browser application, a widget, gadget engine, or other application, and corresponding data 216. The memory 210 may store, for use by the UE 200, any of a variety of various operating systems or combinations of operating systems.

The memory 210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 210 may allow the UE 200 to access instructions, application programs and the like, stored on transitory or non-transitory memory media, to off-load data, or to upload data. An article of manufacture, such as one utilizing a communication system may be tangibly embodied as or in the memory 210, which may be or comprise a device-readable storage medium.

The processing circuitry 202 may be configured to communicate with an access network or other network using the communication interface 212. The communication interface 212 may comprise one or more communication subsystems and may include or be communicatively coupled to an antenna 222. The communication interface 212 may include one or more transceivers used to communicate, such as by communicating with one or more remote transceivers of another device capable of wireless communication (e.g., another UE or a network node in an access network). Each transceiver may include a transmitter 218 and/or a receiver 220 appropriate to provide network communications (e.g., optical, electrical, frequency allocations, and so forth). Moreover, the transmitter 218 and receiver 220 may be coupled to one or more antennas (e.g., antenna 222) and may share circuit components, software or firmware, or alternatively be implemented separately.

In the illustrated embodiment, communication functions of the communication interface 212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 200 shown in FIG. 9.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 10 shows a network node 300 in accordance with some embodiments. A network node 300 may be configured to act as a network-controlled repeater node as described herein. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)), O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 300 includes a processing circuitry 302, a memory 304, a communication interface 306, and a power source 308. The network node 300 may be composed of multiple physically separate components (e.g., a NodeB component and a RNC component, or a BTS component and a BSC component, etc.), which may each have their own respective components. In certain scenarios in which the network node 300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 300 may be configured to support multiple radio access technologies (RATs). In such embodiments, some components may be duplicated (e.g., separate memory 304 for different RATs) and some components may be reused (e.g., a same antenna 310 may be shared by different RATs). The network node 300 may also include multiple sets of the various illustrated components for different wireless technologies integrated into network node 300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 300.

The processing circuitry 302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 300 components, such as the memory 304, to provide network node 300 functionality.

In some embodiments, the processing circuitry 302 includes a system on a chip (SOC). In some embodiments, the processing circuitry 302 includes one or more of radio frequency (RF) transceiver circuitry 312 and baseband processing circuitry 314. In some embodiments, the radio frequency (RF) transceiver circuitry 312 and the baseband processing circuitry 314 may be on separate chips (or sets of chips), boards, or units, such as radio units and digital units. In alternative embodiments, part or all of RF transceiver circuitry 312 and baseband processing circuitry 314 may be on the same chip or set of chips, boards, or units.

The memory 304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 302. The memory 304 may store any suitable instructions, data, or information, including a computer program, software, an application including one or more of logic, rules, code, tables, and/or other instructions capable of being executed by the processing circuitry 302 and utilized by the network node 300. The memory 304 may be used to store any calculations made by the processing circuitry 302 and/or any data received via the communication interface 306. In some embodiments, the processing circuitry 302 and memory 304 is integrated.

The communication interface 306 is used in wired or wireless communication of signaling and/or data between a network node, access network, and/or UE. As illustrated, the communication interface 306 comprises port(s)/terminal(s) 316 to send and receive data, for example to and from a network over a wired connection. The communication interface 306 also includes radio front-end circuitry 318 that may be coupled to, or in certain embodiments a part of, the antenna 310. Radio front-end circuitry 318 comprises filters 320 and amplifiers 322. The radio front-end circuitry 318 may be connected to an antenna 310 and processing circuitry 302. The radio front-end circuitry may be configured to condition signals communicated between antenna 310 and processing circuitry 302. The radio front-end circuitry 318 may receive digital data that is to be sent out to other network nodes or UEs via a wireless connection. The radio front-end circuitry 318 may convert the digital data into a radio signal having the appropriate channel and bandwidth parameters using a combination of filters 320 and/or amplifiers 322. The radio signal may then be transmitted via the antenna 310. Similarly, when receiving data, the antenna 310 may collect radio signals which are then converted into digital data by the radio front-end circuitry 318. The digital data may be passed to the processing circuitry 302. In other embodiments, the communication interface may comprise different components and/or different combinations of components.

In certain alternative embodiments, the network node 300 does not include separate radio front-end circuitry 318, instead, the processing circuitry 302 includes radio front-end circuitry and is connected to the antenna 310. Similarly, in some embodiments, all or some of the RF transceiver circuitry 312 is part of the communication interface 306. In still other embodiments, the communication interface 306 includes one or more ports or terminals 316, the radio front-end circuitry 318, and the RF transceiver circuitry 312, as part of a radio unit (not shown), and the communication interface 306 communicates with the baseband processing circuitry 314, which is part of a digital unit (not shown).

The antenna 310 may include one or more antennas, or antenna arrays, configured to send and/or receive wireless signals. The antenna 310 may be coupled to the radio front-end circuitry 318 and may be any type of antenna capable of transmitting and receiving data and/or signals wirelessly. In certain embodiments, the antenna 310 is separate from the network node 300 and connectable to the network node 300 through an interface or port.

The antenna 310, communication interface 306, and/or the processing circuitry 302 may be configured to perform any receiving operations and/or certain obtaining operations described herein as being performed by the network node. Any information, data and/or signals may be received from a UE, another network node and/or any other network equipment. Similarly, the antenna 310, the communication interface 306, and/or the processing circuitry 302 may be configured to perform any transmitting operations described herein as being performed by the network node. Any information, data and/or signals may be transmitted to a UE, another network node and/or any other network equipment.

The power source 308 provides power to the various components of network node 300 in a form suitable for the respective components (e.g., at a voltage and current level needed for each respective component). The power source 308 may further comprise, or be coupled to, power management circuitry to supply the components of the network node 300 with power for performing the functionality described herein. For example, the network node 300 may be connectable to an external power source (e.g., the power grid, an electricity outlet) via an input circuitry or interface such as an electrical cable, whereby the external power source supplies power to power circuitry of the power source 308. As a further example, the power source 308 may comprise a source of power in the form of a battery or battery pack which is connected to, or integrated in, power circuitry. The battery may provide backup power should the external power source fail.

Embodiments of the network node 300 may include additional components beyond those shown in FIG. 10 for providing certain aspects of the network node's functionality, including any of the functionality described herein and/or any functionality necessary to support the subject matter described herein. For example, the network node 300 may include user interface equipment to allow input of information into the network node 300 and to allow output of information from the network node 300. This may allow a user to perform diagnostic, maintenance, repair, and other administrative functions for the network node 300.

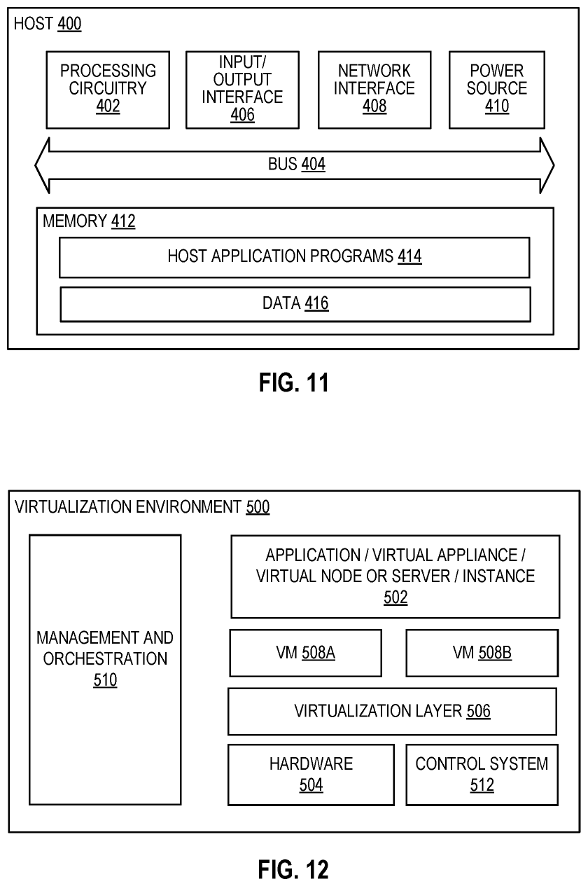

FIG. 11 is a block diagram of a host 400, which may be an embodiment of the host 116 of FIG. 8, in accordance with various aspects described herein. As used herein, the host 400 may be or comprise various combinations hardware and/or software, including a standalone server, a blade server, a cloud-implemented server, a distributed server, a virtual machine, container, or processing resources in a server farm. The host 400 may provide one or more services to one or more UEs.

The host 400 includes processing circuitry 402 that is operatively coupled via a bus 404 to an input/output interface 406, a network interface 408, a power source 410, and a memory 412. Other components may be included in other embodiments. Features of these components may be substantially similar to those described with respect to the devices of previous figures, such as FIGS. 9 and 10, such that the descriptions thereof are generally applicable to the corresponding components of host 400.

The memory 412 may include one or more computer programs including one or more host application programs 414 and data 416, which may include user data, e.g., data generated by a UE for the host 400 or data generated by the host 400 for a UE. Embodiments of the host 400 may utilize only a subset or all of the components shown. The host application programs 414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 414 may also provide for user authentication and licensing checks and may periodically report health, routes, and content availability to a central node, such as a device in or on the edge of a core network. Accordingly, the host 400 may select and/or indicate a different host for over-the-top services for a UE. The host application programs 414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 12 is a block diagram illustrating a virtualization environment 500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 500 includes components defined by the O-RAN Alliance, such as an O-Cloud environment orchestrated by a Service Management and Orchestration Framework via an O-2 interface.

Applications 502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 506 (also referred to as hypervisors or virtual machine monitors (VMMs)), provide VMs 508a and 508b (one or more of which may be generally referred to as VMs 508), and/or perform any of the functions, features and/or benefits described in relation with some embodiments described herein. The virtualization layer 506 may present a virtual operating platform that appears like networking hardware to the VMs 508.

The VMs 508 comprise virtual processing, virtual memory, virtual networking or interface and virtual storage, and may be run by a corresponding virtualization layer 506. Different embodiments of the instance of a virtual appliance 502 may be implemented on one or more of VMs 508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 508 may be a software implementation of a physical machine that runs programs as if they were executing on a physical, non-virtualized machine. Each of the VMs 508, and that part of hardware 504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 508 on top of the hardware 504 and corresponds to the application 502.

Hardware 504 may be implemented in a standalone network node with generic or specific components. Hardware 504 may implement some functions via virtualization. Alternatively, hardware 504 may be part of a larger cluster of hardware (e.g., such as in a data center or CPE) where many hardware nodes work together and are managed via management and orchestration 510, which, among others, oversees lifecycle management of applications 502. In some embodiments, hardware 504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 512 which may alternatively be used for communication between hardware nodes and radio units.

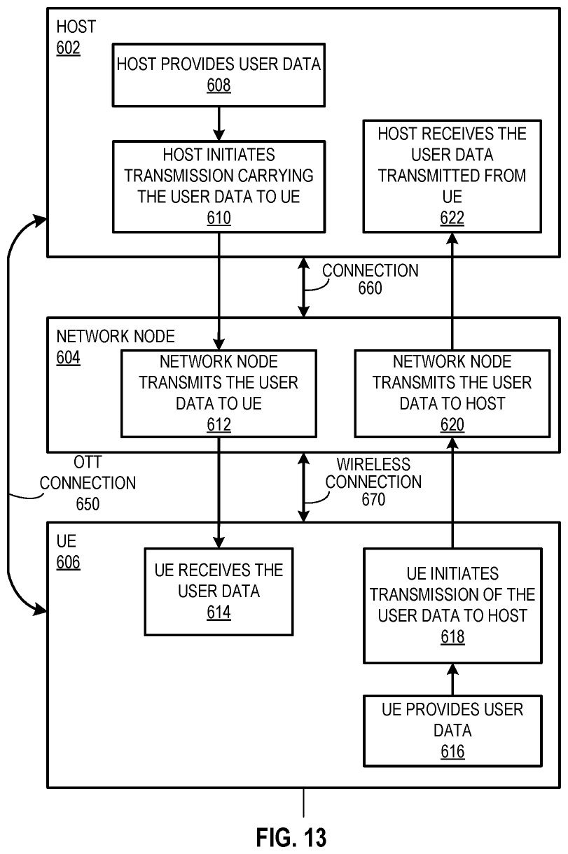

FIG. 13 shows a communication diagram of a host 602 communicating via a network node 604 with a UE 606 over a partially wireless connection in accordance with some embodiments. Example implementations, in accordance with various embodiments, of the UE (such as a UE 112a of FIG. 8 and/or UE 200 of FIG. 9), network node (such as network node 110a of FIG. 8 and/or network node 300 of FIG. 10), and host (such as host 116 of FIG. 8 and/or host 400 of FIG. 11) discussed in the preceding paragraphs will now be described with reference to FIG. 13.

Like host 400, embodiments of host 602 include hardware, such as a communication interface, processing circuitry, and memory. The host 602 also includes software, which is stored in or accessible by the host 602 and executable by the processing circuitry. The software includes a host application that may be operable to provide a service to a remote user, such as the UE 606 connecting via an over-the-top (OTT) connection 650 extending between the UE 606 and host 602. In providing the service to the remote user, a host application may provide user data which is transmitted using the OTT connection 650.

The network node 604 includes hardware enabling it to communicate with the host 602 and UE 606. The connection 660 may be direct or pass through a core network (like core network 106 of FIG. 8) and/or one or more other intermediate networks, such as one or more public, private, or hosted networks. For example, an intermediate network may be a backbone network or the Internet.

The UE 606 includes hardware and software, which is stored in or accessible by UE 606 and executable by the UE's processing circuitry. The software includes a client application, such as a web browser or operator-specific “app” that may be operable to provide a service to a human or non-human user via UE 606 with the support of the host 602. In the host 602, an executing host application may communicate with the executing client application via the OTT connection 650 terminating at the UE 606 and host 602. In providing the service to the user, the UE's client application may receive request data from the host's host application and provide user data in response to the request data. The OTT connection 650 may transfer both the request data and the user data. The UE's client application may interact with the user to generate the user data that it provides to the host application through the OTT connection 650.

The OTT connection 650 may extend via a connection 660 between the host 602 and the network node 604 and via a wireless connection 670 between the network node 604 and the UE 606 to provide the connection between the host 602 and the UE 606. The connection 660 and wireless connection 670, over which the OTT connection 650 may be provided, have been drawn abstractly to illustrate the communication between the host 602 and the UE 606 via the network node 604, without explicit reference to any intermediary devices and the precise routing of messages via these devices.

As an example of transmitting data via the OTT connection 650, in step 608, the host 602 provides user data, which may be performed by executing a host application. In some embodiments, the user data is associated with a particular human user interacting with the UE 606. In other embodiments, the user data is associated with a UE 606 that shares data with the host 602 without explicit human interaction. In step 610, the host 602 initiates a transmission carrying the user data towards the UE 606. The host 602 may initiate the transmission responsive to a request transmitted by the UE 606. The request may be caused by human interaction with the UE 606 or by operation of the client application executing on the UE 606. The transmission may pass via the network node 604, in accordance with the teachings of the embodiments described throughout this disclosure. Accordingly, in step 612, the network node 604 transmits to the UE 606 the user data that was carried in the transmission that the host 602 initiated, in accordance with the teachings of the embodiments described throughout this disclosure. In step 614, the UE 606 receives the user data carried in the transmission, which may be performed by a client application executed on the UE 606 associated with the host application executed by the host 602.

In some examples, the UE 606 executes a client application which provides user data to the host 602. The user data may be provided in reaction or response to the data received from the host 602. Accordingly, in step 616, the UE 606 may provide user data, which may be performed by executing the client application. In providing the user data, the client application may further consider user input received from the user via an input/output interface of the UE 606. Regardless of the specific manner in which the user data was provided, the UE 606 initiates, in step 618, transmission of the user data towards the host 602 via the network node 604. In step 620, in accordance with the teachings of the embodiments described throughout this disclosure, the network node 604 receives user data from the UE 606 and initiates transmission of the received user data towards the host 602. In step 622, the host 602 receives the user data carried in the transmission initiated by the UE 606.

One or more of the various embodiments improve the performance of OTT services provided to the UE 606 using the OTT connection 650, in which the wireless connection 670 forms the last segment. More precisely, the teachings of these embodiments may improve the OTT connection with respect to, e.g., data rate, latency, power consumption and thereby provide benefits such as, e.g., reduced user waiting time, relaxed restriction on file size, improved content resolution, better responsiveness, extended battery lifetime].

In an example scenario, factory status information may be collected and analyzed by the host 602. As another example, the host 602 may process audio and video data which may have been retrieved from a UE for use in creating maps. As another example, the host 602 may collect and analyze real-time data to assist in controlling vehicle congestion (e.g., controlling traffic lights). As another example, the host 602 may store surveillance video uploaded by a UE. As another example, the host 602 may store or control access to media content such as video, audio, VR or AR which it can broadcast, multicast or unicast to UEs. As other examples, the host 602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 650 between the host 602 and UE 606, in response to variations in the measurement results. The measurement procedure and/or the network functionality for reconfiguring the OTT connection may be implemented in software and hardware of the host 602 and/or UE 606. In some embodiments, sensors (not shown) may be deployed in or in association with other devices through which the OTT connection 650 passes; the sensors may participate in the measurement procedure by supplying values of the monitored quantities exemplified above, or supplying values of other physical quantities from which software may compute or estimate the monitored quantities. The reconfiguring of the OTT connection 650 may include message format, retransmission settings, preferred routing etc.; the reconfiguring need not directly alter the operation of the network node 604. Such procedures and functionalities may be known and practiced in the art. In certain embodiments, measurements may involve proprietary UE signaling that facilitates measurements of throughput, propagation times, latency and the like, by the host 602. The measurements may be implemented in that software causes messages to be transmitted, in particular empty or ‘dummy’ messages, using the OTT connection 650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### EMBODIMENTS

### Group A Embodiments

A method by a network node operating as a repeater node, the method comprising: any of the user equipment or network node steps, features, or functions described above, either alone or in combination with other steps, features, or functions described above.

The method of the previous embodiment, further comprising one or more additional user equipment steps, features or functions described above.

The method of any of the previous embodiments, further comprising: providing user data; and forwarding the user data to a host computer via the transmission to the network node.

A network node having hardware configured to operate as a repeater node, the method comprising: any of the user equipment or network node steps, features, or functions described above, either alone or in combination with other steps, features, or functions described above.

### Group B Embodiments

A method performed by a repeater node, the method comprising: providing a capability report to a base station; receiving one or more ON/OFF configurations from the base station; determining a mode of operation for the R-Fwd according to the one or more ON/OFF configuration messages and/or timer types; configuring the R-Fwd according in a configuration to the determined mode; and powering ON/OFF according to the configuration.

A method performed by a network node, the method comprising: receiving a capability report from a repeater node; determining one or more ON/OFF configurations for the repeater node; and transmitting the one or more ON/OFF configurations to the repeater node.

### Group C Embodiments

A network node for configuring or operation as a repeater node, the network node comprising: processing circuitry configured to perform any of the steps of any of the Group B embodiments; and power supply circuitry configured to supply power to the processing circuitry.

A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.

The host of the previous embodiment, wherein: the processing circuitry of the host is configured to execute a host application that provides the user data; and the UE comprises processing circuitry configured to execute a client application associated with the host application to receive the transmission of user data from the host.

A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B embodiments to transmit the user data from the host to the UE.

The method of the previous embodiment, further comprising, at the network node, transmitting the user data provided by the host for the UE.

The method of any of the previous 2 embodiments, wherein the user data is provided at the host by executing a host application that interacts with a client application executing on the UE, the client application being associated with the host application.

A communication system configured to provide an over-the-top (OTT) service, the communication system comprising: a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.

The communication system of the previous embodiment, further comprising: the network node; and/or the UE.

A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.

The host of the previous 2 embodiments, wherein: the processing circuitry of the host is configured to execute a host application that receives the user data; and the host application is configured to interact with a client application executing on the UE, the client application being associated with the host application.

The host of the any of the previous 2 embodiments, wherein the initiating receipt of the user data comprises requesting the user data.

A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B embodiments to receive the user data from the UE for the host.

The method of the previous embodiment, further comprising at the network node, transmitting the received user data to the host.

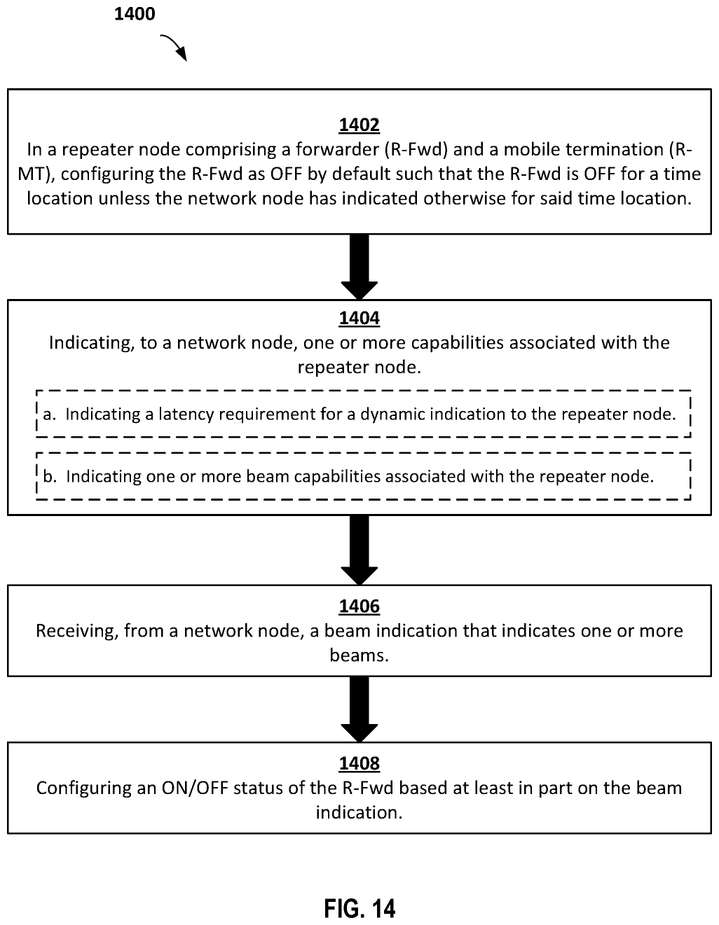

FIG. 14 illustrates an example of a method 1400 that may be performed by a repeater node, such as repeater node 20 illustrated in any of FIGS. 3-5. In certain embodiments, the repeater node comprises R-MT and R-Fwd. In certain embodiments, the repeater node is a network-controlled repeater or a node with similar functionalities. In certain embodiments, the repeater node comprises at least one processor (such as processing circuitry comprising one or more processors) configured to perform one or more steps of method 1400. In certain embodiments, the repeater node comprises a computer-readable medium (such as memory) comprising instructions that, when executed by the at least one processor, cause the at least one processor to perform any of the steps of method 1400.

In certain embodiments, method 1400 may begin at step 1402 with configuring the R-Fwd as OFF by default. Configuring the R-Fwd as OFF by default may facilitate improved interference management and improved energy efficiency because the R-Fwd is OFF for a time location unless a network node has indicated otherwise for said time location. With respect to the time locations for which the network node has indicated that the R-Fwd can be ON, the decision whether to turn ON the R-Fwd may further depend on other factors, such as the RRC state of the R-MT, as further explained below.

In certain embodiments, method 1400 may proceed to step 1404 with indicating, to a network node, one or more capabilities associated with the repeater node. As an example, the network node may be a base station, such as gNB 10, and the repeater node may be configured to extend coverage of a serving cell of the network node. The one or more capabilities may be indicated to the network node together or separately using any suitable message(s), information element(s), field(s), parameter(s), etc. As an example, the repeater node may send a capability report to the network node. The capability report may include one or more capabilities such as: function as a repeater, beam arrangement report, R-Fwd's reliance on R-MT, ON/OFF capability, latency requirements for dynamic indication, and/or power allocation capability.

In the example shown in FIG. 14, the one or more capabilities indicated at step 1404 include a latency requirement for a dynamic indication to the repeater node. In particular, step 1404a shows method 1400 indicating, to the network node, a latency requirement for a dynamic indication to the repeater node. The latency requirement may be based on a decoding time for a dynamic indication.

In the example shown in FIG. 14, the one or more capabilities indicated at step 1404 include one or more beam capabilities associated with the repeater node. In particular, step 1404b shows method 1400 indicating, to the network node, one or more beam capabilities associated with the repeater node. Examples of beam capabilities may include one or more of: size of antenna sub-plane, number of FFT beams, beam hierarchy, number of beams (e.g., per each type of beam), beam arrangement, polarization of the beam, and/or beam expansion capability, as further described above with respect to FIG. 6. In certain embodiments, one or more beam capabilities may be indicated in a beam arrangement report (which may be included, for example, in a capability report).

Method 1400 proceeds to 1406 with the repeater node receiving a beam indication from the network node. In certain embodiments, the repeater node receives the beam indication at the R-MT, for example, via an antenna, modem, and/or other suitable circuitry. The R-MT may facilitate configuring the ON/OFF status of the repeater node's R-Fwd, for example, via a controller or other suitable circuitry.

The beam indication received in step 1406 may comprise a dynamic indication, a semi-static configuration, or a semi-persistent configuration. As an example, in certain embodiments, a dynamic indication may be indicated using DCI. As another example, in certain embodiments, a semi-static configuration may be indicated using RRC signaling. As another example, in certain embodiments, a semi-persistent configuration may be indicated using RRC signaling and activated/deactivated by MAC-CE message.

As an example, RRC signaling may be used to configure a list of configurations for a semi-static configuration or a semi-persistent configuration. The configurations may include configuration information related to the beam indication as well as other configuration information (e.g., related to other features). With respect to the configuration information related to the beam indication, the configuration information may comprise one or more FWD resource sets (e.g., a set of resources is one sub-configuration). A FWD resource set may comprise one or more FWD resources. Each FWD resource may consist of a pair of {beam index, time resource}. For a semi-static configuration, all sets are always activated. For a semi-persistent configuration, configured FWD resource sets can be individually activated or deactivated via a MAC-CE that indicates a respective set ID of each FWD resource set to be activated or deactivated. In this manner, a portion of the configurations can be activated or deactivated without having to revoke the corresponding RRC configuration.

The beam indication received in step 1406 indicates one or more beams. In certain embodiments, the one or more beams indicated by the network node in step 1406 correspond to one or more of the beams for which beam capabilities were provided to the network node in step 1404b. In certain embodiments, the beam indication indicates which of the beams the repeater node may use to transmit signals to or receive signals from one or more UEs and/or to transmit signals to or receive signals from the gNB. The beam indication may further indicate a time location or multiple time locations, which may be periodic or aperiodic (or semi-persistent). A time location may correspond to one or more time domain resources. In certain embodiments, the beam indication indicates that the repeater node may transmit signals during a time location, thereby indicating that the R-Fwd may be ON during that time location. In certain embodiments, the beam indication indicates that the repeater node may not transmit signals during a time location, thereby indicating that the R-Fwd shall be OFF during that time location. Depending on the embodiment, the R-Fwd may be powered ON/OFF per beam (e.g., based on the indicated beam(s)) or for all beams (e.g., the indicated beam(s) and other beam(s)) in the relevant band (e.g., entire bandwidth or a sub-band thereof). As an example, in certain embodiments, each FWD resource consists of a pair {a beam indication, a time resource} without simultaneous operation of beams. Other embodiments may configure simultaneous operation, in which case one FWD resource can consist of {multiple beam indices, time resource}.

In certain embodiments, such as for certain embodiments using a dynamic indication, the time location may depend in part on the latency requirement provided to the network node in step 1404a. For example, the beam indication may introduce an offset between a time when the repeater node receives the beam indication and a time location when the repeater node may transmit the indicated beam, and the offset may depend at least in part on the latency requirement.

In step 1408, the method configures an ON/OFF status of the R-Fwd based at least in part on the beam indication. In this manner, as described above with respect to FIG. 6, the ON/OFF status of the R-Fwd can be related to another R-Fwd configuration (such as beam indication). The beam indication may implicitly indicate when the R-Fwd can (or must) be ON or OFF. In other words, a network node may use a beam indication to jointly configure (a) when a beam may be transmitted by the repeater node, and (b) when the network node permits (or requires) the R-Fwd to be ON or OFF.

The R-Fwd may be configured at any suitable level of granularity. For example, certain embodiments configure the ON/OFF status for an entire R-Fwd bandwidth. Other embodiments configure the ON/OFF status for a sub-band of the entire R-Fwd bandwidth. For example, the sub-band may correspond to FR1 or FR2. This allows separate sub-bands to be configured separately such that their ON/OFF time locations might or might not overlap.

In certain embodiments, the beam indication received in step 1406 indicates a special state of a beam. As an example, the special state of the beam may be configured by OAM to indicate to the network node and/or the repeater node to take a certain action, such as to turn off one or more beams of the R-Fwd. As described above with respect to FIG. 6, in certain embodiments, the special state of the beam may indicate a NULL beam. If the beam indication in step 1406 indicates the NULL beam, then step 1408 configures the R-Fwd as OFF.

In certain embodiments, configuring the ON/OFF status of the R-Fwd in step 1408 comprises following the beam indication received in step 1406, regardless of the RRC state of the R-MT. Examples of this are described above with respect to FIG. 6. As one example, the beam indication may indicate a semi-static configuration and/or a dynamic indication for the R-Fwd ON/OFF status. Table 1 (discussed above) includes an option where the R-Fwd ON/OFF status follows its semi-static configuration and/or dynamic indication when the R-MT is in RRC_CONNECTED, follows its semi-static configuration when the R-MT is in RRC_INACTIVE, and follows its semi-static configuration when the R-MT is in RRC_IDLE. In this manner, if a beam indication is received (step 1406), then step 1408 configures the R-Fwd to be ON over the indicated time locations/time domain resources associated with the corresponding beam(s).

In other embodiments, configuring the ON/OFF status of the R-Fwd in step 1408 depends in part on the RRC state of the R-MT. For example, step 1408 configures the ON/OFF status of the R-Fwd to follow the beam indication at least when the RRC state of the R-MT is RRC_CONNECTED. Similarly, step 1408 configures the ON/OFF status of the R-Fwd to follow the beam indication at least when the RRC state of the R-MT is RRC_INACTIVE (e.g., if the beam indication indicates a semi-static configuration and the corresponding cell is still the serving cell). However, step 1408 configures the ON/OFF status of the R-Fwd as OFF when the RRC state of the R-MT is RRC_IDLE. Examples of this are described above with respect to FIG. 6, including with respect to Table 1. Below, Table 2 illustrates an embodiment derived from options shown in Table 1.

TABLE 2
Relation between R-MT's RRC state and R-Fwd's ON/OFF behavior.

| | R-MT in | R-MT in | R-MT in |
|---|---|---|---|
| | RRC_CONNECTED | RRC_INACTIVE | RRC_IDLE |
| R-Fwd | R-Fwd follows its semi- | R-Fwd follows its semi- | R-Fwd follows the |
| ON/OFF | static configuration | static configuration (see | MT's RRC state (see |
| | and/or dynamic | Table 1, option 1). | Table 1, option 2). |
| | indication. | | |

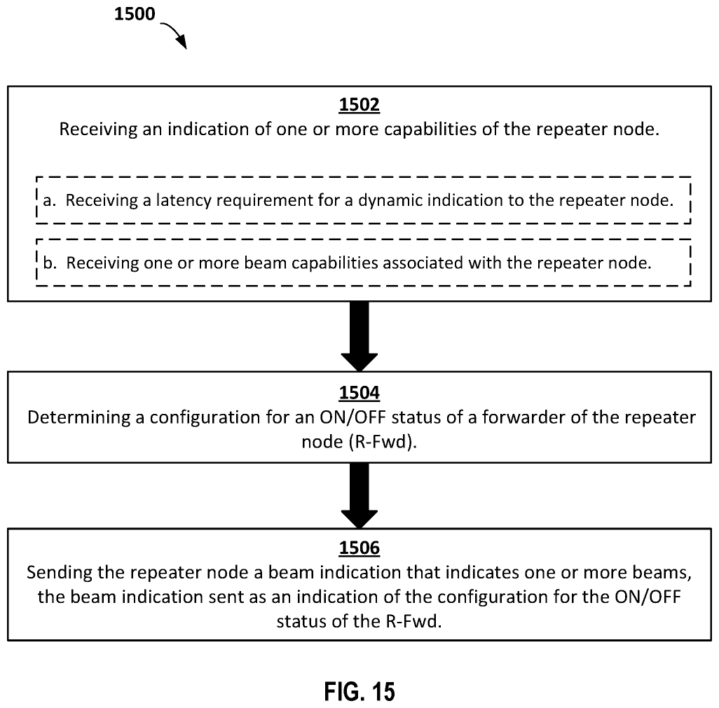

FIG. 15 illustrates an example of a method 1500 that may be performed by a network node, such as the network node (gNB 10) of any of FIGS. 3-5, network node 110 of FIG. 8, network node 300 of FIG. 10, or network node 604 of FIG. 13. As an example, in certain embodiments, the network node comprises at least one processor (such as processing circuitry 302) configured to perform one or more steps of method 1500. In certain embodiments, the network node comprises a computer-readable medium (such as memory 304) comprising instructions that, when executed by the at least one processor, cause the at least one processor to perform any of the steps of method 1500.

In certain embodiments, method 1500 begins at step 1502 with receiving an indication of one or more capabilities associated with the repeater node. The one or more capabilities may be received from the repeater node, OAM, gNB-CU, and/or other suitable node or combination of nodes. Certain embodiments receive one or more capabilities via RRC, MAC-CE, or other suitable signaling. The one or more capabilities may be received together or separately using any suitable message(s), information element(s), field(s), parameter(s), etc. As an example, one or more capabilities may be received in a capability report.

More specifically, the example illustrated in FIG. 15 shows the network node receiving an indication of a latency requirement for a dynamic indication to the repeater node (step 1502a) and an indication of one or more beam capabilities associated with the repeater node (step 1504b). In certain embodiments, the network node may receive in step 1502 the one or more capabilities that the repeater node sends to the network node in step 1404 of FIG. 14 (such as the indication of the latency requirement from step 1404a and/or the indication of one or more beam capabilities from step 1404b). Certain embodiments use one or more of the capabilities received in step 1502 (such as the latency requirement, one or more beam capabilities, and/or one or more other capabilities) when determining a configuration for an ON/OFF status of the R-Fwd in step 1504.

The method proceeds to step 1504 with determining a configuration for an ON/OFF status of R-Fwd. For example, the network node may determine to configure R-Fwd as ON to facilitate communication with one or more UEs in the coverage of the repeater node. Or, the network node may determine to configure R-Fwd as OFF for power-saving or interference reduction. In certain embodiments, the network node may determine the configuration for the ON/OFF status of the R-Fwd implicitly, for example, by determining whether to allocate time domain resources to one or more beams of the repeater node. Determining the configuration in step 1504 may be based at least in part on the one or more capabilities received in step 1502. As an example, the network node may determine a time location for a beam based at least in part on the repeater node's latency requirement received in step 1502a (e.g., to allow the repeater node sufficient decoding time for a dynamic indication). As another example, the network node may select one or more beams based at least in part on beam capabilities received in step 1502b.

The method continues to step 1506, where the network node sends a beam indication to the repeater node. The beam indication indicates one or more beams. The beam indication is sent as an indication of the configuration for the ON/OFF status of the R-Fwd. For example, the beam indication may indicate time locations for transmitting the one or more beams, thereby indicating when the R-Fwd may be ON. In certain embodiments, the R-Fwd is configured as OFF by default such that the R-Fwd is OFF for a time location unless the network node has indicated otherwise for said time location. The beam indication sent in step 1506 provides a dynamic indication, a semi-static configuration, or a semi-persistent configuration for configuring the ON/OFF status of the R-Fwd (for further explanation of these options, see the description of FIG. 14 at step 1406).

The ON/OFF status of the R-Fwd may be configured at any suitable level of granularity, such as for an entire R-Fwd bandwidth or for a sub-band thereof (e.g., FR1 or FR2).

In certain embodiments, the beam indication sent in step 1506 indicates a special state of a beam, such as a NULL beam indicating to configure the R-Fwd as OFF.

In certain embodiments, the beam indication sent in step 1506 indicates a configuration for the ON/OFF status that applies to the R-Fwd regardless of the RRC state of the R-MT. In other embodiments, the configuration for the ON/OFF status of the R-Fwd depends at least in part on the RRC state of the R-MT. As an example, in certain embodiments, the beam indication indicates a configuration for the ON/OFF status that applies to the R-Fwd when the RRC state of the R-MT is RRC_CONNECTED or RRC_INACTIVE. However, when the RRC state of the R-MT is RRC_IDLE, the repeater node is allowed to configure the R-Fwd as OFF. In other words, when the RRC state of the R-MT is RRC_IDLE, the repeater node is not required to turn the R-Fwd on during the ON time locations indicated by the beam indication. Additional examples are described above with respect to FIG. 7.

In certain embodiments, a repeater node and a network node may perform reciprocal operations. For example, a message sent from a repeater node to a network node may be received by the network node from the repeater node, and vice versa. Thus, the description of steps performed by one node provides context for reciprocal steps performed by the other node.

Modifications, additions, or omissions may be made to the methods described herein without departing from the scope of the disclosure. The methods may include more, fewer, or other steps. Additionally, steps may be performed in any suitable order.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the scope of this disclosure.

1. A method in a repeater node comprising a forwarder (R-Fwd) and a mobile termination (R-MT), the method comprising:
receiving, from a network node, a beam indication that indicates one or more beams; and
configuring an ON/OFF status of the R-Fwd based at least in part on the beam indication.

2. The method of claim 1, further comprising:
configuring the R-Fwd as OFF by default such that the R-Fwd is OFF for a time location unless the network node has indicated otherwise for said time location.

3. The method of claim 1, wherein the beam indication indicates a special state of a beam.

4. The method of claim 1, wherein the beam indication indicates a NULL beam and wherein configuring the ON/OFF status of the R-Fwd comprises configuring the R-Fwd as OFF based on the beam indication indicating the NULL beam.

5. The method of claim 1, wherein the beam indication provides a dynamic indication, a semi-static configuration, or a semi-persistent configuration for configuring the ON/OFF status of the R-Fwd.

6. The method of claim 1, wherein the R-Fwd follows the beam indication for configuring the ON/OFF status of the R-Fwd at least when a radio resource control (RRC) state of the R-MT is RRC_CONNECTED.

7. The method of claim 1, further comprising:
configuring the R-Fwd as OFF when a radio resource control (RRC) state of the R-MT is RRC_IDLE.

8. The method of claim 1, wherein the beam indication provides a semi-static configuration for configuring the ON/OFF status of the R-Fwd, and wherein the R-Fwd follows the semi-static configuration at least when a radio resource control (RRC) state of the R-MT is RRC_INACTIVE.

9. The method of claim 1, wherein the R-Fwd follows the beam indication for configuring the ON/OFF status of the R-Fwd regardless of a radio resource control (RRC) state of the R-MT.

10. The method of claim 1, further comprising:
indicating, to the network node, a latency requirement for a dynamic indication to the repeater node.

11. The method of claim 1, further comprising:
indicating, to the network node, one or more beam capabilities associated with the repeater node.

12. The method of claim 1, wherein:
configuring the ON/OFF status of the R-Fwd comprises configuring the ON/OFF status of the R-Fwd for an entire R-Fwd bandwidth.

13. The method of claim 1, wherein:
configuring the ON/OFF status of the R-Fwd comprises configuring the ON/OFF status of the R-Fwd for a sub-band of an entire R-Fwd bandwidth.

14.-15. (canceled)

16. A repeater node, the repeater node comprising:
processing circuitry associated with forwarding (R-Fwd) and mobile termination (R-MT), wherein the processing circuitry is configured to:
receive, from a network node, a beam indication that indicates one or more beams; and
configure an ON/OFF status of the R-Fwd based at least in part on the beam indication.

17.-30. (canceled)

31. A method in a network node, the method comprising:
determining a configuration for an ON/OFF status of a forwarder of a repeater node (R-Fwd); and
sending the repeater node a beam indication that indicates one or more beams, the beam indication sent as an indication of the configuration for the ON/OFF status of the R-Fwd.

32. The method of claim 31, wherein the R-Fwd is configured as OFF by default such that the R-Fwd is OFF for a time location unless the network node has indicated otherwise for said time location.

33.-36. (canceled)

37. The method of claim 31, wherein the configuration for the ON/OFF status indicated by the beam indication does not apply when a radio resource control (RRC) state of a mobile termination of the repeater node (R-MT) is RRC_IDLE, thereby allowing the repeater node to configure the R-Fwd as OFF when the RRC state of the R-MT is RRC_IDLE.

38. The method of claim 31, wherein the beam indication provides a semi-static configuration for configuring the ON/OFF status of the R-Fwd and wherein the beam indication applies to the R-Fwd at least when a radio resource control (RRC) state of a mobile termination of the repeater node (R-MT) is RRC_INACTIVE.

39. (canceled)

40. The method of claim 31, further comprising:
receiving an indication of a latency requirement for a dynamic indication to the repeater node;
wherein determining the configuration for the ON/OFF status of the R-Fwd is based at least in part on the indicated latency requirement.

41. The method of claim 31, further comprising:
receiving an indication of one or more beam capabilities associated with the repeater node;
wherein determining the configuration for the ON/OFF status of the R-Fwd is based at least in part on the indicated one or more beam capabilities associated with the repeater node.

42.-60. (canceled)
